(19) United States
(12) Patent Application Publication
(10) Pub. No.: US 2006/0215834 A1
(43) Pub. Date: Sep. 28, 2006

(54) Retractable phone apparatus

(76) Inventor: Mong-Tsang Tsai, Taipei City (TW)

Correspondence Address: HDSL, 4331 STEVENS BATTLE LANE, FAIRFAX, VA, 22033, US

(21) Appl. No.: 11/090,060

(22) Filed: Mar. 28, 2005

(51) Int. Cl. H04M 1/00

(52) U.S. Cl. 379/419

(57) ABSTRACT

A retractable phone apparatus comprising a telephone transmitter and a socket. The telephone transmitter comprises keys, a receiver, and a transmitter. The socket is connected with the telephone transmitter by a communication line disposed on a communication line disk, thereby providing a wider activities space when the telephone is in use and increasing the working efficiency.

### BACKGROUND OF THE INVENTION

1. Field of the Invention

The present invention relates to a retractable phone apparatus, and more specifically, to a telephone having an extendable telephone line, which provides more convenience when the telephone is in use.

2. Description of the Related Art

The use of the telephone apparatus is necessary at home or the office. Because the quality of the communication is more stable and the calling fee is cheaper, the corded telephone is still widely used. Normally, the home phone and the office phone are located on a specific place, for examples, on the wall or on the table. A cord is connected between the telephone transmitter and the telephone base, resulting in limiting the telephone transmitter by the communication line. The caller can not go far away. If the user is on the phone and needs to do something else, for examples, getting out to open the door, or getting files, the user needs to hold the telephone. People are often busy, and needs to do a lot of work within a limited time.

### SUMMARY OF THE INVENTION

The present invention provides a retractable phone apparatus, which provides a wider activities space when the telephone is in use and provides the user more convenience.

The present invention also provides a retractable phone apparatus, which can do other operation while calling, thereby greatly increasing the working efficiency.

According to a preferred embodiment of the present invention, a retractable phone apparatus is provided, comprising a telephone transmitter and a socket. The telephone transmitter comprises keys, a receiver, and a transmitter. The socket is connected with the telephone transmitter by a communication line disposed on a communication line disk.

According to another preferred embodiment of the present invention, comprising a cord winder, connecting to a socket with having an electrically signal connection, a retractable communication line with a length is wound around the cord winder, and the retractable communication line has one end disposed a plug for generating an electrically signal connection with a telephone transmitter.

The objectives of the present invention will become obvious to those of ordinary skill in the art after reading the following detailed description of the preferred embodiment.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a perspective view of a retractable phone apparatus according to a first embodiment of the present invention;

FIG. 2 is a perspective view of a retractable phone apparatus applied on the table according to a first embodiment of the present invention;

FIG. 3 is a perspective view of a retractable phone apparatus applied on the wall according to a first embodiment of the present invention;

FIG. 4 is a perspective view of a retractable phone apparatus according to a second embodiment of the present invention;

FIG. 5 is a perspective view of a retractable phone apparatus according to a third embodiment of the present invention; and

FIG. 6 is a perspective view of a cord winder according to another embodiment of the present invention.

### DETAILED DESCRIPTION OF THE PREFERRED EMBODIMENTS

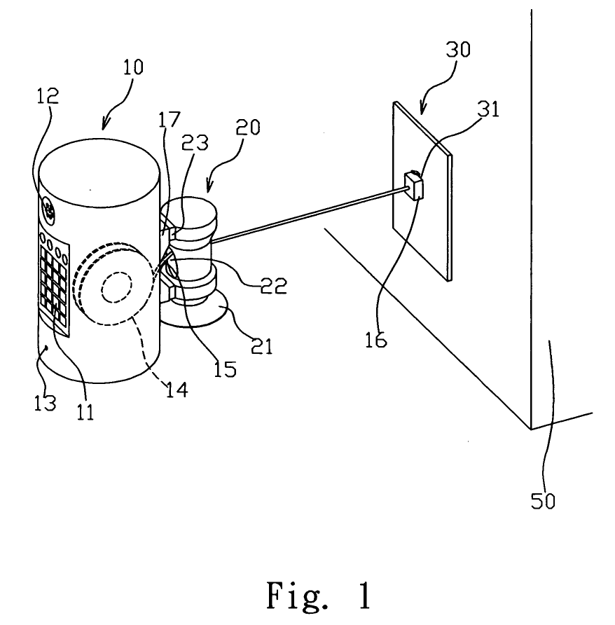

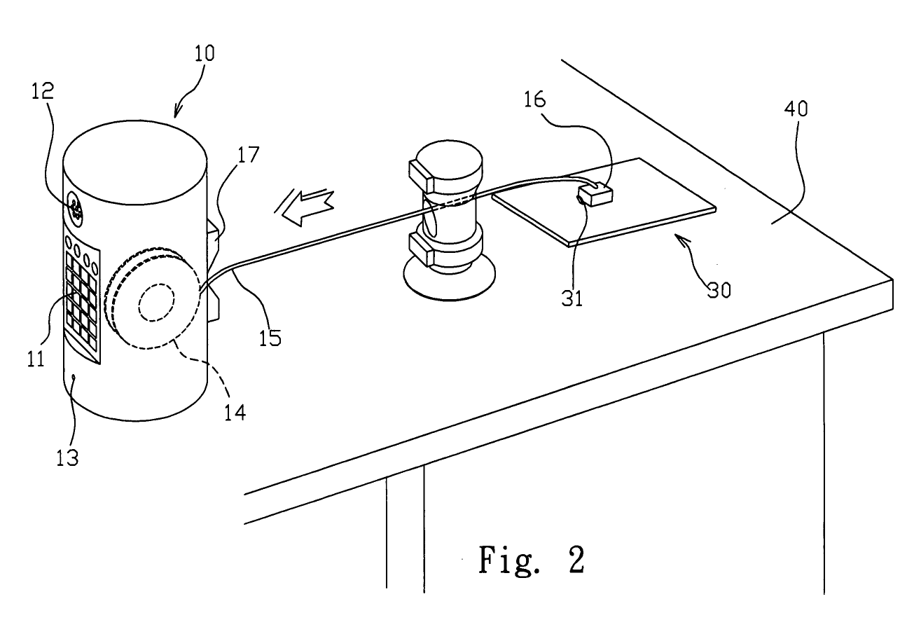

Refer to FIG. 1, which is a perspective view of a retractable phone apparatus according to a first embodiment of the present invention, comprising a telephone transmitter 10, a telephone base 20 and a socket 30. The telephone transmitter 10 comprises keys 11, a receiver 12 (for examples, an earphone), and a transmitter 13 (for examples, a microphone). A communication line disk 14 is disposed on the telephone transmitter 10. A communication line 15 having a length is wound around the communication line disk 14 with an extendable and automatically retractable apparatus. The retractable communication line 15 has one end disposed a contact 16. The telephone transmitter 10 further comprises a magnetic sucking device 17. The telephone base 20 further comprises a sucking disk 21 and a through hole 22 disposed thereon. The sucking disk 21 is used to fasten on the table 40 or other proper position, thereby fastening the telephone transmitter 10 by the telephone base 20. The sucking disk 21 is also used to fasten by other ways. The through hole 22 is provided for passing through by the communication line 15 to form a fixedly position. The telephone base 20 further comprises a magnetic sucking device 23 disposed thereon to generate a fixedly sucking function with the magnetic sucking device 17, in order to attach the telephone transmitter 10 on the telephone base 20. The socket 30 is disposed on the wall 50 or the table 40 (as shown in FIG. 2) or other proper position. The socket 30 has a jack 31 to connect with the contact 16 for generating an electrically signal connection.

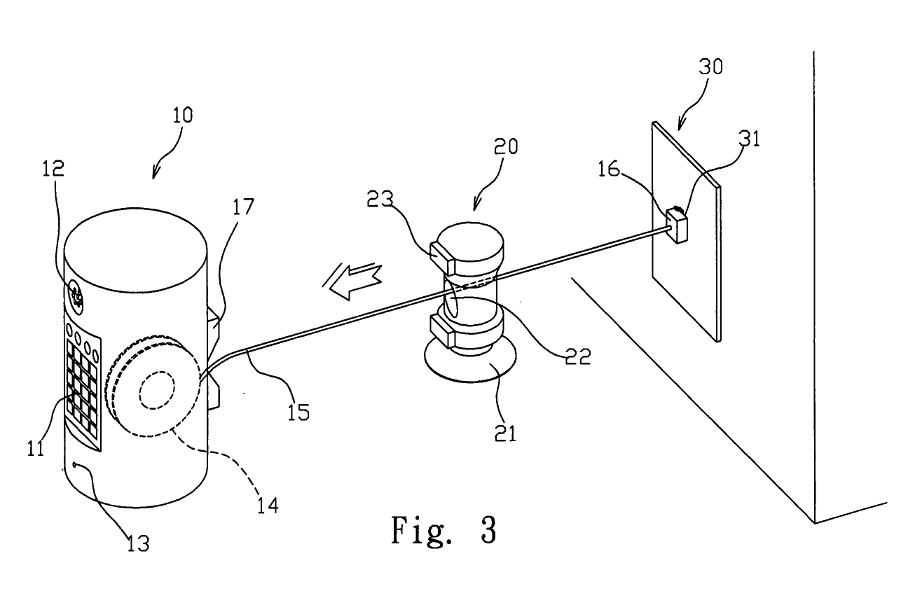

As shown in FIGS. 2 and 3, which are the perspective views of applying a retractable phone apparatus according to a first embodiment of the present invention. Since the telephone transmitter 10 has the communication line disk 14 disposed thereon, the communication line 15 is retractable as moving the telephone transmitter 10 when the telephone transmitter 10 is in use, thereby expanding the moving scope without limiting the space for user.

When the calling is over, the telephone transmitter 10 is placed on the telephone base 20, and the communication line disk 14 is atomically retractable independent of the resistance of the telephone transmitter 10, thereby rolling the extended communication line 15 into the communication line disk 14, as shown in FIG. 1.

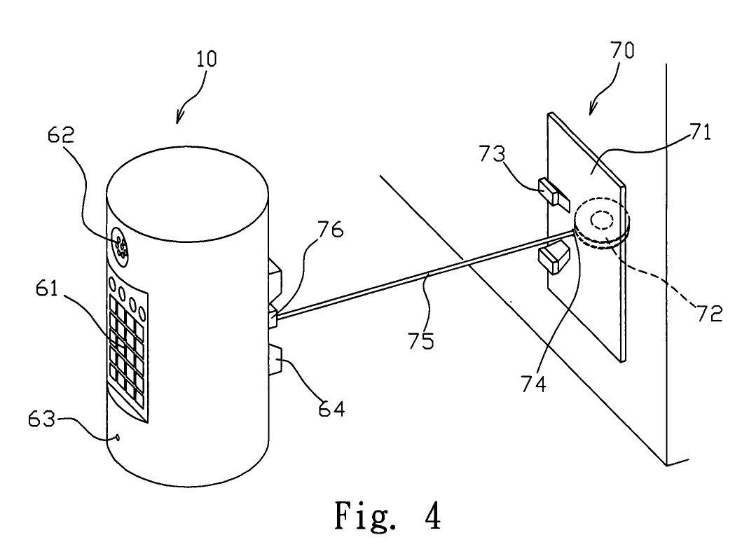

As shown in FIG. 4, which is a perspective view of a retractable phone apparatus according to a second embodiment of the present invention, comprising a telephone transmitter 60 and a socket 70. The telephone transmitter 60 comprises keys 61, a receiver 62 (for examples, an earphone), and a transmitter 63 (for examples, a microphone). The telephone transmitter 60 comprises a magnetic sucking device 64 and a communication hole (not shown) disposed thereon. The socket 70 comprises a panel 71 and a communication line disk 72. The panel 71 has a magnetic sucking device 73 and a through hole 74 disposed thereon. The magnetic sucking device 73 generates a fixedly sucking function with the magnetic sucking device 64, in order to attach the telephone transmitter 60 on the panel 71. A communication line 75 having a length is wound around the communication line disk 72 with an extendable and automatically retractable apparatus. The communication line 75 passes through the through hole 74, and has one end disposed a plug 76. The plug 76 is connected with the jack of the telephone transmitter 60 for generating an electrically signal connection.

When the telephone transmitter 60 is in use, the communication line 75 is retractable as moving the telephone transmitter 60 since the socket 70 has the communication line disk 72 disposed thereon, thereby expanding the moving scope without limiting the space for users.

When the calling is over, the telephone transmitter 60 is placed on the panel 71, and the communication line disk 72 is atomically retractable independent of the resistance of the telephone transmitter 60, thereby rolling the extended communication line 75 into the communication line disk 72.

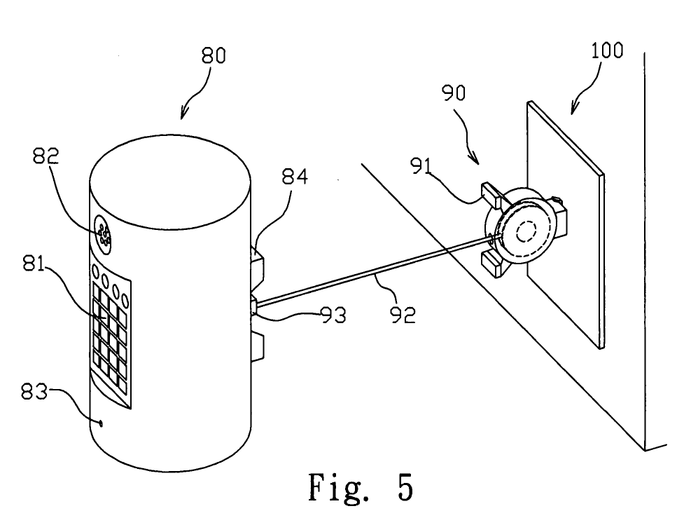

As shown in FIG. 5, which is a perspective view of a retractable phone apparatus according to a third embodiment of the present invention, comprising a telephone transmitter 80 and a cord winder 90. The telephone transmitter 80 comprises keys 81, a receiver 82 (for examples, an earphone), and a transmitter 83 (for examples, a microphone). The telephone transmitter 80 comprises a magnetic sucking device 84 and a communication hole (not shown) disposed thereon. The cord winder 90 is electrically connected with a socket 100 having a jack (not shown) disposed thereon. The cord winder 90 is connected with the socket 100 by the telephone line, or is directly disposed on the socket 100. The cord winder 90 comprises a magnetic sucking device 91 to attach the telephone transmitter 80. The telephone transmitter 80 and the cord winder 90 can be combined by other hitching ways. A communication line 92 having a length is wound around the cord winder 90 with an extendable and automatically retractable apparatus. The communication line 92 has one end disposed a plug 93. The plug 93 is connected with the jack of the telephone transmitter 80 for generating an electrically signal connection.

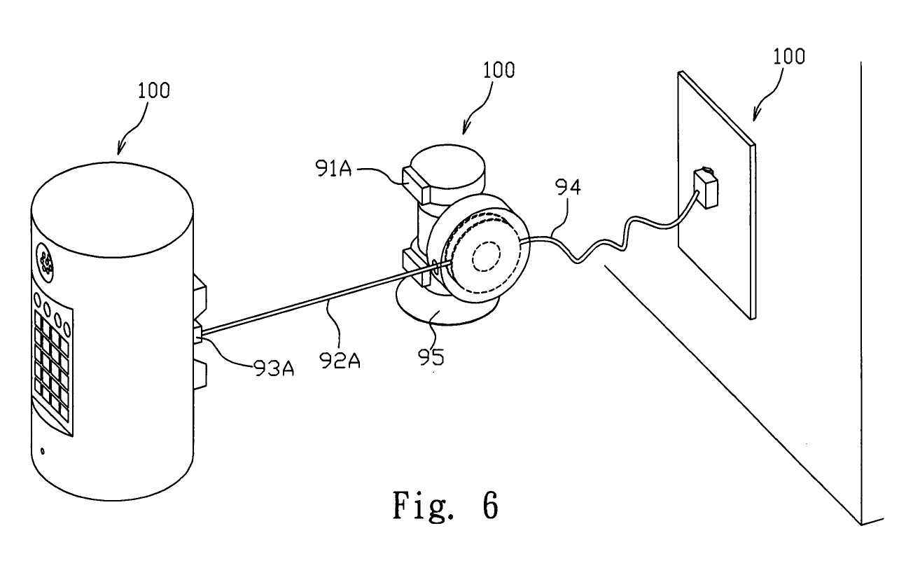

As shown in FIG. 6, which is a perspective view of the cord winder according to another embodiment of the present invention. The cord winder 90A has a jack (not shown) disposed thereon, and is connected with the socket 100 by a telephone line 94. Alternatively, a telephone line can be directly extended from the cord winder 90A to connect with the socket 100. The cord winder 90A comprises a magnetic sucking device 91A to attach the telephone transmitter 80. The telephone transmitter 80 and the cord winder 90A can be combined by other hitching ways. A communication line 92A having a length is wound around the cord winder 91A with an extendable and automatically retractable apparatus. The communication line 92A has one end disposed a plug 93A. The plug 93A is connected with the jack of the telephone transmitter 80 for generating an electrically signal connection. The cord winder 90A further comprises a fixing member 95 disposed thereon. The fixing member 95 can be a sucking disk or other members for fastening on the table 40 or the wall.

The embodiment above is only intended to illustrate the present invention; it does not, however, to limit the present invention to the specific embodiment. Accordingly, various modifications and changes may be made without departing from the spirit and scope of the present invention as described in the following claims.

What is claimed is:

1. A retractable phone apparatus, comprising:
a telephone transmitter having keys, a receiver, and a transmitter thereon;
a socket connecting with the telephone transmitter by a communication line disposed on a communication line disk.

2. The retractable phone apparatus of claim 1, wherein the communication line disk is disposed on the telephone transmitter or the socket.

3. The retractable phone apparatus of claim 1, wherein the telephone transmitter further comprises a magnetic sucking device disposed thereon, and the socket further comprises a correspondingly magnetic sucking device disposed thereon.

4. The retractable phone apparatus of claim 1, wherein the communication line passes through a telephone base.

5. The retractable phone apparatus of claim 4, wherein the telephone base comprises a sucking disc disposed thereon.

6. The retractable phone apparatus of claim 4, wherein the telephone base comprises a magnetic sucking device disposed thereon.

7. A retractable phone apparatus, comprising a cord winder connecting to a socket with having an electrically signal connection, a retractable communication line with a length wound around the cord winder, the retractable communication line having one end disposed a plug for generating an electrically signal connection with a telephone transmitter.

8. The retractable phone apparatus of claim 7, wherein the cord winder comprises a telephone line extended therefrom.

9. The retractable phone apparatus of claim 7, wherein the cord winder comprises a fasten device disposed thereon.

10. The retractable phone apparatus of claim 9, wherein the fasten device is used to fasten a sucking device or other members.
